(19) United States
(12) Patent Application Publication
(10) Pub. No.: US 2004/0020919 A1
(43) Pub. Date: Feb. 5, 2004

(54) Container and welding method therefor

(76) Inventors: Takashi Hirano, Yokohama-shi (JP); Toyonobu Nabemoto, Kamakura-shi (JP)

Correspondence Address: FISH & RICHARDSON P.C., 45 ROCKEFELLER PLAZA, SUITE 2800, NEW YORK, NY, 10111, US

(21) Appl. No.: 10/211,761

(22) Filed: Aug. 2, 2002

(51) Int. Cl. H05B 6/10

(52) U.S. Cl. 219/604; 219/617

(57) ABSTRACT

A container containing radioactive materials consists of a canister and a cover which is fixed to an opening of the canister, and the canister and the cover are welded by magnetic welding. The canister has a uniform thickness in the vicinity of the opening.

### BACKGROUND OF THE INVENTION

1. Field of the Invention

The invention relates to a container which consists of a canister and a cover which is attached to an opening of the canister, and also relates to a welding method therefor.

2. Description of the Prior Art

FIG. 3 shows a conventional container for dry storage cask which is used for containing radioactive materials such as spent nuclear fuel. A container C shown in FIG. 3 comprises a canister (drum part having a cylindrical shape) 1 which comprises a bottom plate 2, a shield 4 which is arranged in an opening 3 of the canister 1, a first cover 5, and a second cover 6. The shield 4 is supported by a shield supporting ring 7 which is arranged on an inner surface of the canister 1 in the vicinity of the opening 3. The first cover 5 is arranged above the shield 4. The second cover 6 is arranged above the first cover 5. The canister 1, the first cover 5, and the second cover 6 are made of stainless steel or a nickel alloy.

FIG. 4 is an enlarged cross-sectional view of the part in the vicinity of the opening 3 of the container C which is shown in FIG. 3. As shown in FIG. 4, the thickness of an upper end portion in the vicinity of the opening 3 of the container C is thinner in the upper part of the upper end portion. The upper end of the container C is fixed to the second cover 6 using a tungsten inert gas welding method (hereinafter referred to as TIG welding method). In FIG. 4, only the second cover 6 is illustrated in the opening 3 of the canister 1 and the shield 4 and the first cover 5 which is welded to the canister 1 using the TIG welding method are not illustrated.

By using the TIG welding method, it is possible to weld a work piece by generating an arc between an electrode made of tungsten or a metal whose main component is tungsten and the work piece in a flow of inert gas such as helium or argon while supplying a filler metal rod to the arc. Because the TIG welding method is suitable for welding various kinds of materials, the covers 5 and 6 are welded to the canister 1 of the container C which contains radioactive materials by the TIG welding method.

It is necessary to examine whether the covers 5 and 6 are sufficiently welded to the canister 1 after welding the covers 5 and 6 to the canister 1. It is also necessary to examine whether the welded part degrades with the passage of time. Ultrasonic inspection is used to inspect the soundness of a welded part. Because the canister 1 and the covers 5 and 6, which are made of stainless steel, are welded by TIG welding, a dendrite structure grows and becomes larger in shape. Due to the above dendrite structure, the following problems occur during ultrasonic inspection.

(i) Because ultrasonic waves are reflected by the dendrite structure, the transmissibility of ultrasonic waves through the weldement decrease, and it becomes difficult to detect defects.

(ii) Because ultrasonic waves which are reflected by the dendrite structure generates false echos resulting in noise and false defects, it becomes difficult to detect a real defect.

(iii) Because ultrasonic waves passing through the dendrite structure bend, the accuracy in detecting the location and dimensions of a defect decreases.

According to the above problems, it has been difficult to inspect a weldement which was welded by TIG welding with sufficient accuracy. Therefore an inspector generally judges whether a defect exists by analyzing of various kinds of inspection data. An inspector detects a defect by analyzing X-ray images. However, the efficiency and reliability of the above inspections are not sufficient.

As shown in FIG. 4, the thickness of the canister 1 in the vicinity of the opening 3 is thinner in the upper part of the canister 1. Because the thickness of the canister thus varies, it is difficult to inspect the canister 1 by ultrasonic inspection from the side of the canister 1.

### SUMMARY OF THE INVENTION

The present invention was made in view of the above-mentioned problems. The present invention seeks to obtain a container whose soundness of the welded portion between a canister and a cover can be stably inspected with excellent accuracy and which has a excellent sealing performance sufficient to, contain radioactive materials such as spent nuclear fuel.

As a solution to the above problems the present invention provides a container which contains radioactive materials and consists of a canister having a cylindrical drum shape for instance and a cover which is fixed to an opening of the canister, wherein the canister and the cover have been welded by magnetic stirring welding.

The magnetic stirring welding means welding where a molten pool by the welding is stirred by a magnetic force in the direction of rotation generated by a magnetic field and an electric current for the welding. Magnetic stirring welding prevents the growth of a dendrite structure during a welding of stainless steel.

Because the canister and the cover are stably welded by magnetic stirring during the welding, the canister which requires a high sealing performance to contain radioactive materials can be sufficiently sealed. Because the growth of a dendrite structure and anisotropy are prevented by magnetic stirring, the weldment can be inspected by ultrasonic inspection with excellent accuracy. Because a weld zone which has been magnetically agitated has good wettability, a first layer of the weld zone has high quality in spite of difficulties in welding.

Because the cover fits the opening, and the thickness of the canister is uniform in the vicinity of the opening, the container can be inspected by ultrasonic inspection from the side of the canister, and the performance of the ultrasonic inspection improves.

The present application also provides a method for welding a container which consists of a canister and a cover which is fixed to an opening of the canister, in which the welding is accomplished while an alternating magnetic field acts on a molten pool by the welding.

Because the growth of a dendrite structure and anisotropy are prevented by magnetic agitation, the weldment can be inspected by ultrasonic inspection with high accuracy. Because a weld zone which has been magnetically stirred has good wettability, a first layer of the weld zone has high quality in spite of difficulties in welding.

### BRIEF DESCRIPTION OF THE DRAWINGS

FIG. 1 is an expanded cross sectional view of a container of a preferred embodiment of the present application.

FIG. 2 is a cross sectional view of the container for explaining the welding of a canister and a cover.

FIG. 3 is a side view of the entire container.

FIG. 4 is an expanded cross sectional view of a conventional container.

### DESCRIPTION OF THE PREFERRED EMBODIMENT

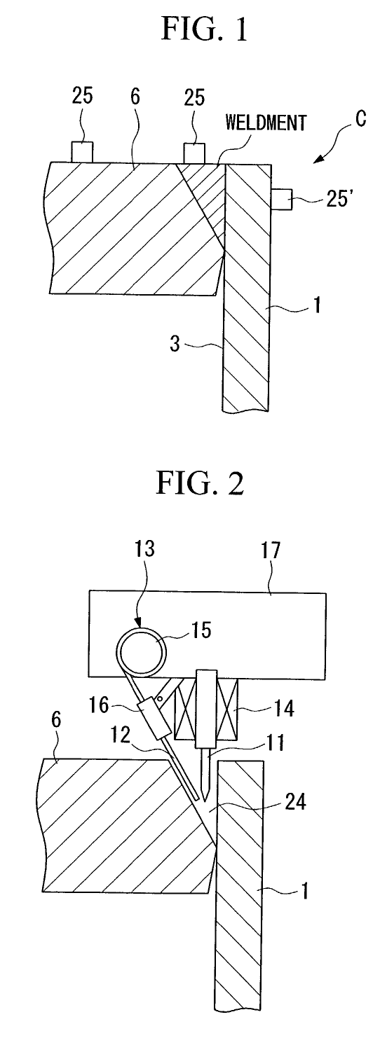

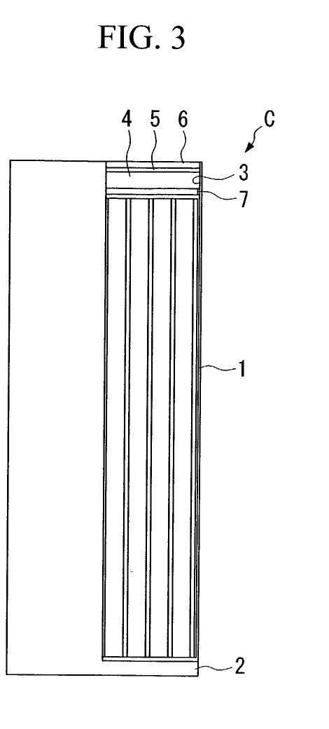

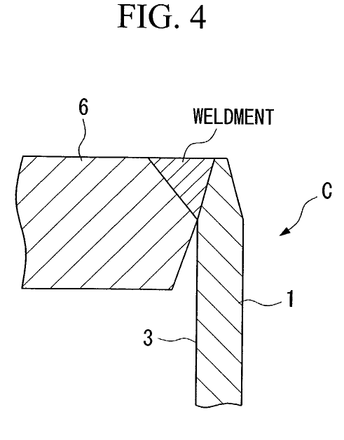

Hereinafter, an embodiment of a container according to the present application will be explained with reference to FIG. 1. In this embodiment, a container basically has the same construction as the container C in FIG. 3. Therefore the same reference numerals are used for the members of the embodiment which are equivalent to those of the container C in FIG. 3 and explanations for the equivalent members are omitted.

FIG. 1 is an expanded cross sectional view of a principal part of the container C in the vicinity of the opening 3. In FIG. 1, the container C consists of a canister (cylindrical body) 1 and a cover (second cover) 6 which fits the opening 3 of the canister 1. This cover 6 fits the opening 3 of the canister 6 and the thickness of the cover 6 is uniform in an inter-fitted part. The canister 1 and the cover 6 are made of stainless steel or a nickel base alloy. The cover 6 is welded to the canister 1. Specifically, an inner face of the canister 1 and the periphery of the cover 6 are welded by magnetic stirring welding.

Next, magnetic stirring welding will be explained with reference to FIG. 2.

As explained in FIG. 2, a welding device such as a TIG welder is used for magnetic welding. This device for the magnetic welding method comprises a torch 11 which consists of a tungsten electrode and a passage for inert gas, a wire supplier 13 which supplies a wire 12 as a filler in the vicinity of the tip of the torch 11. A magnetic coil 14 is arranged around the torch 11. The wire supplier consists of a reel 15, which holds the wire 12 in a wound state, and a guide piece 16 which guides the wire supplied by the reel to the tip of the torch 11. The reel 15, the guide piece 16, and the torch 11 are supported by a main bracket 17 which is mounted on a horizontal transferring mechanism (not shown in the figures) and a vertical transferring mechanism (not shown in the figures) which are supported by a frame of the device (not shown in the figures). The horizontal transferring mechanism and the vertical transferring mechanism transfer the main bracket 17 by using feed screws which are driven manually or electrically.

Welding using the torch 11 thus constructed is performed according to the following steps.

Step 1: Directing the torch 11 to a groove 24 between the round periphery of the cover 6 and the inner surface of the canister 1.

Step 2: Generating an arc from an electrode of the torch 11 (in the embodiment a negative electrode) using a direct current, while generating an alternating magnetic field by the magnetic coil 14. The molten pool in the groove 24 is agitated by an alternating turning force caused by the direct current and the alternating magnetic field.

Step 3: Moving the torch 11 along the groove 24 while delivering the wire 12 and supplying inert gas to the groove 24.

By the welding thus performed, a pool of molten metal originates at the back of the moving torch 11. Because an alternating magnetic turning force which is caused by the magnetic field is generated in the pool of molten metal, the pool is stirred by the turning force and the growth of a dendrite structure is prevented.

The periphery of the cover 6 and the inner surface of the canister are completely welded by magnetic welding thus performed. The above welding process is not only suitable for a welding of the second cover 6 as a cover and the canister 1, but is also suitable for welding of the first cover 5 and the canister 1 which are shown in FIG. 3. The welding for the first cover 5 and the canister 1 is accomplished after the welding for the second cover 6 and the canister 1 in which radioactive materials are contained.

As explained above, because the canister 1 and the cover 6 are stably welded by magnetic welding, the container C, which contains a radioactive materials such as nuclear fuel and which requires sealing performance, obtains a sufficient sealing performance. Because the canister 1 and the cover 6 are welded by magnetic welding, a growth of a dendrite structure in the weld are prevented.

Further, because the growth of a dendrite structure is prevented by magnetic welding, accuracy of the ultrasonic inspection of the soundness of the welded part and degrading of the welded part over time improve.

In other words, the following effects are obtained by preventing the growth of a dendrite structure.

(i) Because ultrasonic waves for inspection are not reflected by a dendrite structure and the transmission ratio of the ultrasonic waves increase, the possibility of detecting welding defects increases.

(ii) Because ultrasonic waves are not reflected by a dendrite structure, a false echo, which causes noise and false defects, is not generated.

(iii) Because ultrasonic waves are not bent by a dendrite structure, the accuracy in detecting the position and dimensions of a defect increases.

As explained in items (i) to (iii) above, it is possible to easily inspect a welded part which is welded using the magnetic welding with an accuracy.

It is also possible to detect the condition of the welded part by ultrasonic inspection probes 25 which are arranged in the vicinity of the weld as shown in FIG. 1. Because the thickness of the canister 1 is uniform in the vicinity of the opening 3, it is possible to inspect the weld using another ultrasonic inspection probe 25′ which is arranged on the side of the canister 1.

Because a weld zone which has been magnetically welded has a good wettability, a first layer of the weld zone has a quality in spite of difficulties in welding.

The container C which is explained as a container for radioactive materials such as nuclear fuel is also suitable for containing other kinds of materials.

What is claimed is:

1. A container which contains radioactive materials and consists of a canister and a cover which is fixed to an opening of said canister, wherein said canister and said cover are welded by magnetic welding.

2. A container according to claim 1, wherein said cover is fit to the opening of said canister, and said canister has a uniform thickness in a vicinity of the opening.

3. A container according to claim 1, wherein an alternating magnetic field acts on a metal molten by the welding.

4. A container according to claim 2, wherein an alternating magnetic field acts to a metal molten by the welding.

5. A container according to claim 3, wherein said alternating magnetic field is generated by a magnetic coil which is arranged around a torch used for the welding.

6. A container according to claim 4, wherein said alternating magnetic field is generated by a magnetic coil which is arranged around a torch used for the welding.

7. A method for welding a container which consists of a canister and a cover which is fixed to an opening of said canister, wherein the welding is performed while an alternating magnetic field acts on a molten pool by the welding.

8. A method for welding according to claim 7, wherein said cover is fit to the opening, and said canister has a uniform thickness in a vicinity of the opening.

9. A method for welding according to claim 7, wherein said alternating magnetic field is generated by a magnetic coil which is arranged around an electrode used for the welding.

10. A method for welding according to claim 8, wherein said alternating magnetic field is generated by a magnetic coil which is arranged around a torch used for the welding.

11. A method for welding according to claim 9, comprising a step of inserting a tip of said torch into a groove between said canister and said cover while supplying a filler metal rod to an arc which is generated by said torch and generating an alternating magnetic field by said magnetic coil which is arranged around a part of the torch except for the tip thereof.

12. A method for welding according to claim 10, comprising a step of inserting a tip of said torch into a groove between said canister and said cover while supplying a filler metal rod to an arc which is generated by said torch and generating an alternating magnetic field by said magnetic coil which is arranged around a part of said torch except for the tip thereof.
